(19) United States
(12) Patent Application Publication
(10) Pub. No.: US 2020/0284513 A1
(43) Pub. Date: Sep. 10, 2020

(54) METHOD FOR CONTROLLING A COMBUSTION AND FURNACE

(71) Applicant: LINDE LLC, Bridgewater, NJ (US)

(72) Inventor: Martin Schöninger, Rediham (AT)

(73) Assignee: Messer LLC, Bridgewater, NJ (US)

(21) Appl. No.: 16/647,180

(22) PCT Filed: Sep. 13, 2018
(86) PCT No.: PCT/EP2018/025233

§ 371 Date: Mar. 13, 2020

(30) Foreign Application Priority Data
Sep. 19, 2017 (DE) 10 2017 008 768.7
Dec. 19, 2017 (EP) 17020581.9

(51) Int. Cl. F27B 7/20; F27D 21/02

(52) U.S. Cl. CPC F27B 7/2083; F27B 2007/365; F27D 21/02

(57) ABSTRACT

The invention relates to a method for controlling a combustion in a furnace (100) which is heated by a burner (160) with at least one oxygen lance (120), wherein a fuel is supplied via a fuel supply (110) of the burner (110) and oxygen is supplied at least in part with a high speed of 100 m/s or more by the at least one oxygen lance (120), and wherein oxygen in an overstoichiometric range is supplied. The invention further relates to a furnace (100) for carrying out said method.

The invention relates to a method of closed-loop control of a combustion in a furnace and to a furnace according to the preambles of the independent claims.

### STATE OF THE ART

In the metal processing industry, it is necessary to optimize melting and casting processes with regard to the aspects that follow. Preheating and heating of melts in a furnace to required temperatures must be performed efficiently, while a loss of heat via offgases must be reduced as far as possible. With conventional heating processes, it can be difficult to control the thermal flame shape and the stoichiometry. Moreover, smoke and fouling and also emissions of harmful gases, for example NOx, are to be avoided. The existing flameless and semi-flameless burner technology offers an effective means of optimizing furnace preheating and heating processes during a combustion of a fuel by an oxyfuel burner. Combustion gases are mixed into the combustion reaction zone in order to dilute the reactants. This distributes the combustion, moves the release of heat, and lowers the peak flame temperature, as a result of which NOx emissions are reduced. The mixing of combustion gases into the flame also distributes the energy throughout the furnace, which ensures faster and more uniform heating. The applicant's melt preheating systems of this kind are known by the OXYGON name (LTOF, REBOX burner).

Another kind of low-temperature oxyfuel technology designed by the applicant particularly for the aluminum industry is known as LTOF (low-temperature oxyfuel). In an aluminum melting furnace, the combustion occurs at a dilute oxygen concentration in that combustion gases are mixed into the combustion zone. This leads to lower flame temperatures below the point at which thermal NOx is produced. Moreover, the energy is distributed throughout the furnace for uniform heating and more efficient melting. Typical advantages are a melt rate up to 50% higher, a fuel consumption up to 50% lower, the avoidance of hotspots in the furnace, reduced offgas volumes and NOx emissions.

These flameless and semi-flameless burner technologies are all based on high-speed oxygen jets to generate the flameless effect. The oxygen output speed is typically the speed of sound in oxygen, around 305 m/s. Speeds over and above about 100 m/s can also be used. The high-speed jets produce very significant recirculation within the furnace gas space, which results in the abovementioned reduced NOx production through reduced peak temperatures within the flame and in very homogeneous heating of the furnace. Such burner technologies have been found to be very effective and useful. However, these burner technologies have not been used to date for the melting of aluminum scrap since sulfur gases are additionally formed therein, and these are not combusted in the known prior art processes.

For the melting of aluminum scrap, the applicant's so-called WASTOX process is known. An amount of oxygen supplied is supplied here depending on combustion gases in the furnace, especially the carbon monoxide or oxygen content. In order to determine the amount of carbon monoxide or oxygen, measurement systems are usually present in an offgas stream, for example in an offgas duct or an offgas flue.

DE 101 14 179 A1 describes, for example, a rotary drum furnace for melting of aluminum scrap. In an exhaust gas duct from the rotary drum furnace, an oxygen detector and a carbon monoxide detector are present. A similar system is disclosed by EP 0 756 014 A1.

It is an object of the invention, in the melting of aluminum scrap, to simultaneously enable optimal combustion of low-temperature carbonization gases and simultaneous heating and more efficient melting with low NOx emission.

What are proposed by the invention are a method of closed-loop control of a combustion in a furnace, and a furnace. Advantageous configurations are the subject-matter of the dependent claims and of the description that follows.

### Advantages of the Invention

According to the invention, in a method of closed-loop control of a combustion in a furnace which is heated by means of a burner having at least one oxygen lance, a fuel is supplied by means of a fuel feed of the burner and oxygen is supplied at least partly at a high speed of 100 m/s or more through the at least one oxygen lance, wherein oxygen is supplied in a superstoichiometric range or ratio. A combustion air ratio (lambda) here is preferably between 1.0 and 2.5, more preferably between 1.2 and 2.3. The burner and the at least one oxygen lance here form one component.

In this way, the advantages of an LTOF burner are combined with the advantages of the WASTOX method. By virtue of oxygen being supplied at a high speed of 100 m/s or more, furnace gases are circulated in a combustion zone, such that an oxygen concentration is diluted in the combustion zone. As a result, the combustion takes place at a lower temperature, and NOx emission is reduced. At the same time, the combustion in the furnace is distributed since the oxygen in the furnace is also distributed, such that uniform heating and efficient melting are enabled. By virtue of oxygen being supplied in the superstoichiometric range, sufficient oxygen is present to combust low-temperature carbonization gases in the furnace and to enable complete combustion of impurities.

Since the LTOF burner already comprises at least one oxygen lance, it is possible to dispense with further oxygen lances that are still required in the WASTOX method. Advantageously, the burner comprises multiple oxygen lances, preferably two to five, more preferably four. In this way, the oxygen can contribute particularly efficiently to uniform circulation of the furnace gases.

In an advantageous embodiment, the oxygen is supplied at least partly with a speed in the region of the speed of sound in oxygen of between 290 m/s and 320 m/s. Such speeds have been found to be particularly appropriate for the desired circulation of the furnace gases.

Appropriately, the burner comprises four oxygen lances through which the oxygen is supplied. This should not be understood in a restrictive manner. For instance, a different number of oxygen lances is also conceivable, preferably two to five. In this way, the oxygen can contribute particularly efficiently to uniform mixing and reactivity of the combustible constituents of the furnace gases. The oxygen lances are preferably integrated into the burner. Separate oxygen lances, especially oxygen lances spaced apart from the burner, are preferably not used.

In a further advantageous embodiment, the oxygen supply is actuated under automatic closed-loop control via an offgas measurement. This is particularly appropriate since offgas values can be used to draw very accurate conclusions as to a stoichiometry of the combustion.

Preference is given to measuring an O₂ content in the offgas measurement. This value can advantageously be used as reference variable for controlling the pyrolysis of impurities and/or in the melting of aluminum. The use of the oxygen value in the offgas results in a reliable closed-loop control criterion under which the furnace can be run. If, on commencement of an aluminum melt, high amounts of hydrocarbons are pyrolyzed without being completely combusted, the oxygen content in the furnace atmosphere will fall. The closed-loop control according to the amount of oxygen in the offgas permits very fine and sensitive dosage of the control of the method in order to assure oxygen supply in a superstoichiometric range.

In a further advantageous embodiment, a CO content is measured in the offgas measurement. Too high a CO value is a sign of insufficient oxygen supply. However, this value is preferably used as a safety variable. In that case, the closed-loop control of the method is via the O₂ value, with the CO measurement as an overriding safety variable. With this double safeguard, the transition from burnoff by low-temperature carbonization to the combustion of the resultant low-temperature carbonization gases in the furnace vessel is assured with sufficient reliability.

Alternatively or additionally, the oxygen supply is preferably actuated under automatic closed-loop control via a measurement of a flame signal. Offgas measurements determine the amount of oxygen or carbon monoxide outside the furnace or outside a combustion space of the furnace. The offgas measurement is thus time-delayed. In the case of measurement of the flame signal, the flame of the ignited combustion gas or the spectrum of this flame is utilized in order to detect the combustion gas present in the furnace.

This can be implemented, for example, with an inexpensive UV probe and/or a spectrometer or a UV light probe which can be mounted outside the furnace without difficulty in such a way that they look onto, for example, an annular gap in the furnace. If the furnace flames out, i.e. uncombusted components of the furnace atmosphere react with the ambient air, the UV probe can detect a flame signal. Advantageously, the detected UV component of the spectrum of the flame is used to determine an amount of the combustion gas. The higher a proportion of the combustion gas to be detected in the furnace atmosphere, the higher the flame development and the more significant the UV component of the flame spectrum. Advantageously, an amount of the oxygen supplied through the oxygen supply is adjusted or subjected to open-loop or closed-loop control depending on the combustion gas detected. In particular, a superstoichiometric combustion ratio at which complete combustion takes place is thus established.

Optionally, as well as the (UV) sensor, a small amount of oxygen may also be added in order to ignite it in the event that CO is present and to produce a flame visible to the sensor and hence to start the closed-loop control process.

Said actuations under automatic closed-loop control should not be understood in a restrictive manner. For instance, it is also conceivable that the oxygen supply is actuated manually. In this way, a stoichiometric ratio can also be established by sight, for example, by operational experience.

In a further advantageous embodiment, a rotary drum furnace is utilized as furnace. This is advantageous since the combustion here can additionally be subjected to closed-loop control via an adjustment of the rotary motion of the furnace.

Preferably, contaminated aluminum scrap is melted in the furnace. By means of a semi-flameless burner flame with high convection, the aluminum scrap is heated, which leads to pyrolysis of organic components of the aluminum scrap. This pyrolysis gives rise, for example, to carbon dioxide as combustion gas.

Stopping of the rotating motion of the rotary drum furnace causes a smaller aluminum surface area and hence lower pyrolysis of the components. As a result, the oxygen content of a furnace atmosphere may rise again and can always be kept within the superstoichiometric range. If the closed-loop control then recognizes that there is less pyrolysis, the furnace can be run up again in steps, which increases the aluminum surface area and allows new pyrolysis to take place again, in which new hydrocarbons are combusted to give CO. The latter can be combusted completely to CO₂ by adding sufficient O₂ or, if this is insufficient, can lead back to stoppage of the furnace, which reduces pyrolysis again. In this way, the furnace can reliably be run automatically even if very large amounts of organic impurities adhering to the aluminum have been added. Purifying and comminution steps prior to the melting can thus be dispensed with, which makes the overall operation of the plant cheaper.

In a further aspect of the invention, a furnace is proposed. The furnace serves for performance of a method as described above and comprises a burner with at least one oxygen lance, wherein the burner is configured to supply the furnace with a fuel via a fuel supply, wherein the at least one oxygen lance is configured to supply oxygen at a high speed of 100 m/s or more through the at least one oxygen lance to the furnace, wherein the furnace has a sensor unit for detection of a stoichiometry and a control unit that adjusts the oxygen supply depending on a signal from the sensor unit in such a way that an oxygen concentration is within a superstoichiometric range.

It will be apparent that the aforementioned features and those still to be elucidated hereinafter are usable rot just in the particular combination specified but also in other combinations and on their own without leaving the scope of the present invention.

The invention is shown schematically in the drawing with reference to a working example and is described in detail hereinafter with reference to the drawing.

### DESCRIPTION OF FIGURES

FIG. 1 shows a schematic of a preferred configuration of a furnace of the invention which is in the form of a rotary drum furnace and is set up to perform a preferred embodiment of a method of the invention.

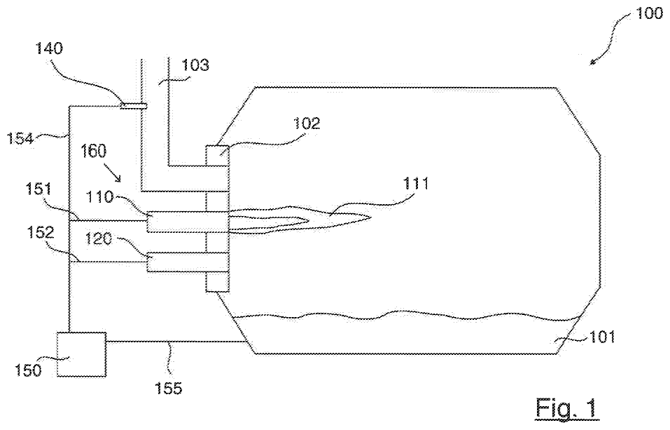

The sole FIGURE, FIG. 1, shows a schematic of a furnace in the form of a rotary drum furnace, labeled 100. The rotary drum furnace 100 in this specific example is set up to melt contaminated aluminum scrap 101. By means of a door 102, the aluminum scrap 101 can be introduced into the rotary drum furnace 100. In addition, the rotary drum furnace 100 is closed by means of the door 102. The rotary drum furnace 100 also has a burner 160 having a fuel supply 110 that may be disposed in the door 102, for example.

The burner 110 takes the form of an LTOF burner and also has an oxygen supply in the form of at least one oxygen lance 120. By means of the oxygen lance 120, an amount of oxygen is supplied to the rotary drum furnace 100. The oxygen is supplied at a high speed of 100 m/s or more. More particularly, the amount of oxygen is such that oxygen is supplied in a superstoichiometric range.

The burner flames 111 and 121 from the burner 110 heat the aluminum scrap 101, which leads to pyrolysis of the aluminum scrap 101, especially of organic components of the aluminum scrap 101. This forms carbon monoxide as combustion gas. Offgas is removed via an offgas duct 103 in an offgas stream from the rotary drum furnace 100.

By virtue of the high speed or high momentum with which the amount of oxygen is supplied to the rotary drum furnace through the oxygen lance 120, the carbon monoxide and the other combustion gases circulates in the rotary drum furnace 100 and is sucked in by the gas flowing out of the oxygen lance 120. Since the oxygen is injected at high speed (above 100 m/s), no flame in the conventional sense can form; instead, a semi-flameless flame (not shown) propagates with high convection. The rotary drum furnace or a control unit 150 are set up to perform a preferred embodiment of a method of the invention.

In this embodiment, a sensor device 140 is disposed in the offgas duct 103, where it detects an amount of oxygen or an amount of carbon monoxide. This sensor device 140, which may possibly also be a UV probe, is connected to the control unit 150 via a connection 154.

The particular amount of carbon monoxide and other reaction gases is utilized to adjust the amount of oxygen supplied through the oxygen lance 120, especially in the course of closed-loop control. Depending on the determined amount of carbon monoxide and other reaction gases, the control unit 150 calculates the amount of oxygen to supply oxygen in a superstoichiometric ratio. Accordingly, the control unit 150 actuates the oxygen lance 120, indicated by reference numeral 152, in order that the determined amount of oxygen is supplied to the rotary drum furnace 100.

In addition, the control unit 150 appropriately controls a rotary motion of the rotary drum furnace 100, indicated by reference numeral 155.

In addition, as well as the sensor device 140, an oxygen inlet may also be provided, by means of which a small amount of oxygen can be added, in order to ignite CO in the event of the presence thereof, and to produce a flame visible to the sensor device 140 and hence to start the closed-loop control process.

1-12. (canceled)

13. A method of closed-loop control of combustion in a furnace (100) heated by a burner (160) having at least one oxygen lance (120), compromising: supplying fuel by a fuel feed (110) of the burner (160); and supplying oxygen at least partly at a speed of at least 100 ms through the at least one oxygen lance (120), wherein the supplying the oxygen is in a superstoichiometric range.

14. The method of claim 13, wherein the oxygen is at least partly supplied at a speed in the region of the speed of sound in oxygen of between 290 m/s and 320 m/s.

15. The method of claim 13, wherein the burner comprises a plurality of the oxygen lances (120) through which the oxygen is supplied.

16. The method of claim 13, further comprising actuating the oxygen supply under automatic closed-loop control via an offgas measurement.

17. The method of claim 16, further comprising measuring a content of the oxygen in the offgas measurement.

18. The method of claim 16, further comprising measuring a CO content and/or a content of other reaction gases in the offgas measurement.

19. The method of claim 13, further comprising actuating the oxygen supply under automatic closed-loop control via a measurement of a flame signal.

20. The method of claim 19, further comprising measuring the flame signal with a UV light sensor.

21. The method of claim 13, further comprising manually actuating the oxygen supply.

22. The method of claim 13, wherein the furnace (100) comprises a rotary drum furnace.

23. The method of claim 13, wherein the furnace (100) melts contaminated aluminum scrap (101).

24. A furnace (100) having closed-loop control of combustion in the furnace, comprising:
a burner (160) having at least one oxygen lance (120), the burner (160) configured to supply fuel via a fuel supply (110), and the at least one oxygen lance (120) configured to supply oxygen at a speed of at least 100 m/s through the at least one oxygen lance (120);
a sensor unit (140) for detection of a stoichiometry; and
a control unit (150) to adjust the oxygen supply responsive to a signal from the sensor unit (140) such that an oxygen concentration supplied is within a superstoichiometric range.
